(19) United States
(12) Patent Application Publication
(10) Pub. No.: US 2015/0165612 A1
(43) Pub. Date: Jun. 18, 2015

(54) FLOORING NAILER HAVING AN INVERTABLE OBJECT ABUTMENT MEMBER

(71) Applicant: BASSO INDUSTRY CORP., Taichung (TW)

(72) Inventors: Yao-Sheng Shen, Taichung (TW); An-Gi Liu, Taichung (TW); Wen-Cheng Lo, Taichung (TW)

(21) Appl. No.: 14/570,603

(22) Filed: Dec. 15, 2014

(30) Foreign Application Priority Data
Dec. 16, 2013 (TW) 102146380

(51) Int. Cl. B25C 7/00

(52) U.S. Cl. CPC B25C 7/00

(57) ABSTRACT

A nailer includes a base seat and at least one abutment member. The base seat has at least one engaging structure. The abutment member has at least two engaging portions that are spaced apart from each other, and a connecting portion that is connected between the engaging portions. The engaging structure engages detachably one of the engaging portions. Each of the engaging portions has an engaging surface that is connected to the connecting portion and that abuts against the engaging structure. The other one of the engaging portions further has an abutment surface that is opposite to the engaging surface thereof, and that is for abutting against the object.

### CROSS-REFERENCE TO RELATED APPLICATION

This application claims priority of Taiwanese Application No. 102146380, filed on Dec. 16, 2013.

### FIELD OF THE INVENTION

The invention relates to a nailer, more particularly to a flooring nailer that includes an invertable abutment member for contact with an object (i.e., flooring).

### BACKGROUND OF THE INVENTION

Referring to FIG. 1, Taiwanese Utility Model Patent No. M250773 discloses a conventional flooring nailer 1 that includes a base 11, a magazine 12, an abutment member 13 and a latch member 14. The base 11 is formed with a plurality of positioning grooves 111. The magazine 12 is connected to the base 11. The abutment member 13 is connected movably to the base 11. The latch member 14 is threaded drivingly to the abutment member 13, and engages one of the positioning grooves 111 for positioning the abutment member 13 relative to the base 11. The conventional flooring nailer 1 can fire a nail to a desired position of an object when engaging the latch member 14 with a corresponding positioning groove 111.

However, to adjust the conventional flooring nailer 1, the latch member 14 need to be rotated to lock or release the abutment member 13 relative to the base 11 repeatedly. Such operation is laborious.

### SUMMARY OF THE INVENTION

Therefore, the object of the present invention is to provide a nailer that can overcome the aforesaid drawbacks associated with the prior art.

Accordingly, a nailer of the present invention includes a base seat and at least one abutment member. The base seat has at least one engaging structure. The abutment member has at least two engaging portions that are spaced apart from each other, and a connecting port ion that is connected between the engaging portions. The engaging structure engages detachably one of the engaging portions. Each of the engaging portions has an engaging surface that is connected to the connecting portion and that abuts against the engaging structure. The other one of the engaging portions further has an abutment surface that is opposite to the engaging surface thereof, and that is for abutting against the object.

### BRIEF DESCRIPTION OF THE DRAWINGS

Other features and advantages of the present invent ion will become apparent in the following detailed description of the embodiments with reference to the accompanying drawings, of which:

FIG. 1 is a perspective view of a conventional flooring nailer disclosed in Taiwanese Utility Model Patent No. M250773;

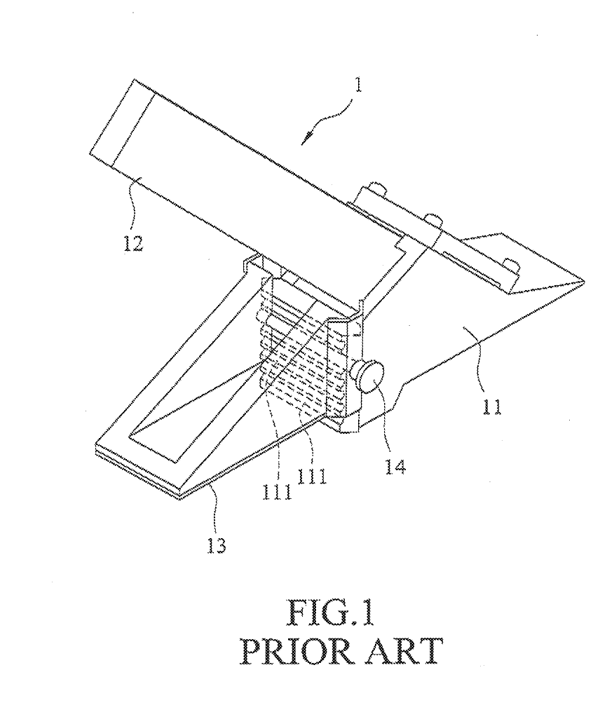

FIG. 2 is an exploded perspective view of a first embodiment of a nailer according to the invention;

FIG. 3 is a perspective view of the first embodiment;

FIG. 4 is a sectional view of the first embodiment;

FIG. 5 is another sectional view of the first embodiment taken along line V-V in FIG. 4;

FIG. 6 is a fragmentary partly sectional view of the first embodiment;

FIG. 7 is a fragmentary sectional view of the first embodiment;

FIG. 8 is still another sectional view of the first embodiment; and

FIG. 9 is an exploded perspective view of a second embodiment of a nailer according to the invention.

### DETAILED DESCRIPTION OF THE EMBODIMENTS

Before the present invention is described in greater detail, it should be noted that like elements are denoted by the same reference numerals throughout the disclosure.

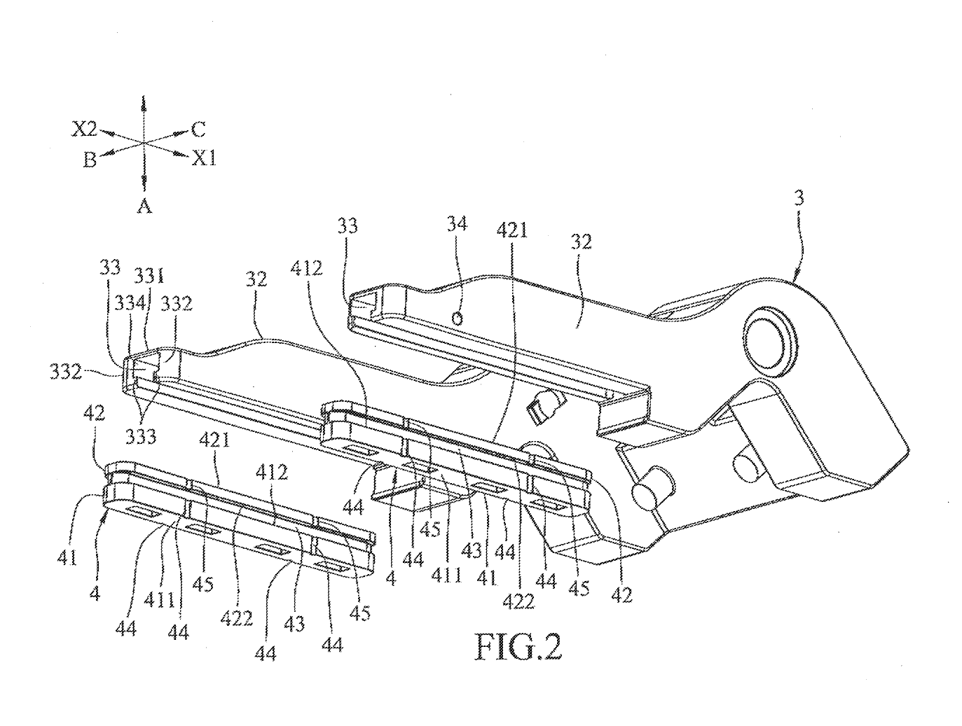

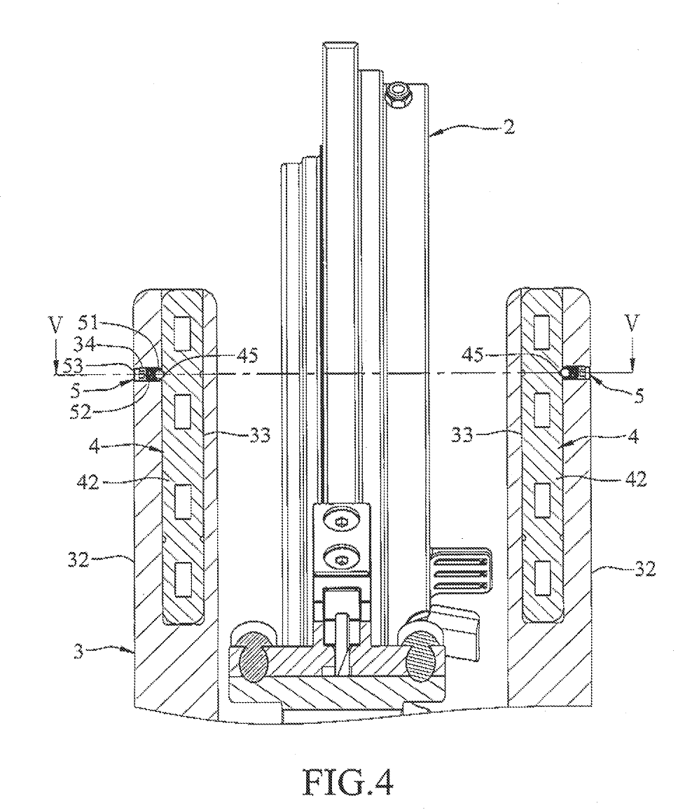

As shown in FIGS. 2 to 6, a first embodiment of a nailer according to the present invention is for firing a nail 21 into an object 6, and includes a magazine 2, a base seat 3, two abutment members 4 and two positioning units 5.

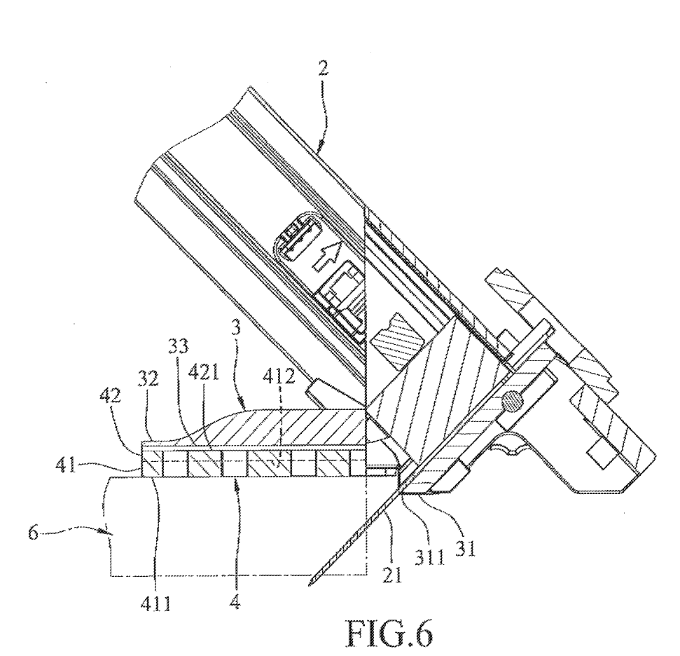

The magazine 2 is for receiving a plurality of nails 21 (only one is shown in FIG. 6).

The base seat 3 has a main body 31 and two support portions 32. The main body 31 is connected to the magazine 2, and is formed with a nail passage 311 (see FIG. 6). The support portions 32 are spaced apart from each other and connected to the main body 31. Each of the support portions 32 has an engaging structure 33 that has an elongate top wall segment 331, a pair of spaced-apart extending wall segments 332 parallel to each other and extending from the top wall segment 331 toward the object 6 in a first direction (A), and a pair of distal wall segments 333 extending respectively from distal ends of the extending wall segments 332 proximate to the object 6 toward each other in opposite second and third directions (B, C). The top wall segment 331, the extending wall segments 332 and the distal wall segments 333 of each of the support portions 32 cooperatively define an engaging space 334 thereamong that extends in an engaging direction (X1) transverse to the first, second and third direct ions (A, B, C). Each of the support portions 32 further has a retaining hole 34 that is formed in one of the extending wall segments 332 thereof, and that communicates spatially with the engaging space 334 thereof.

The abutment members 4 correspond respectively to the support portions 32 of the base seat 3. For simplification, one of the abutment members 4 is described in the following.

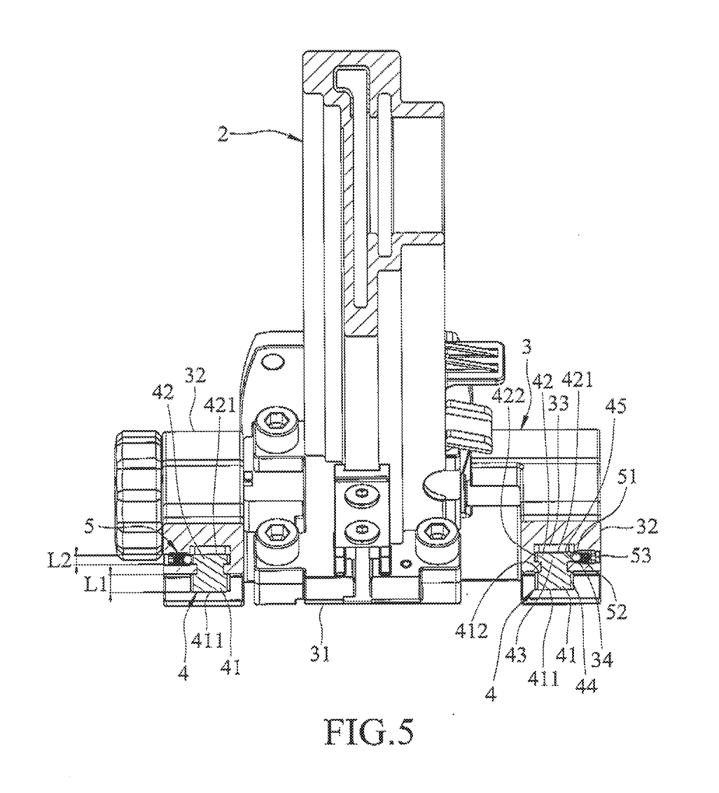

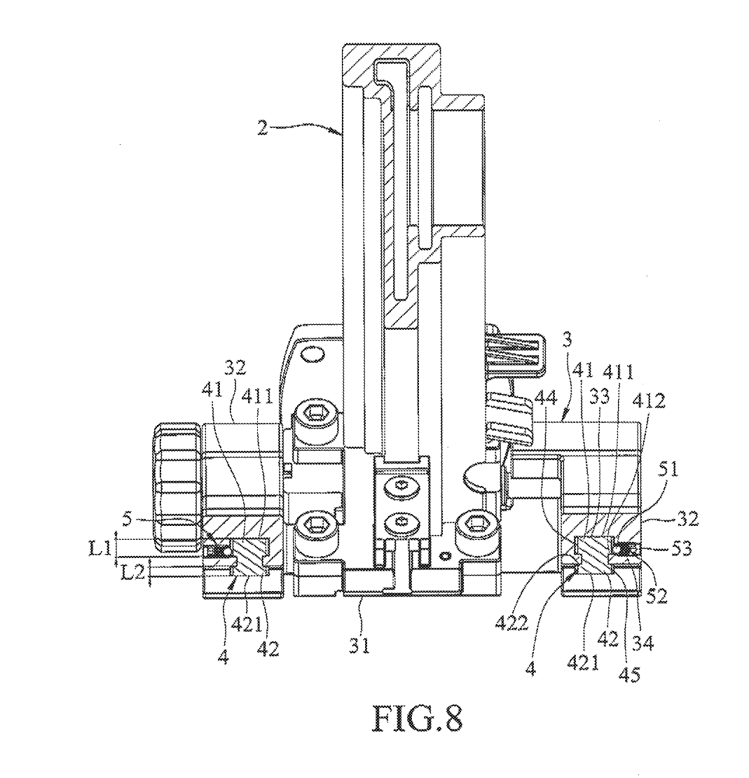

The abutment member 4 has first and second engaging portions 41, 42 that are spaced apart from each other, and a connecting portion 43 that is connected between the first and second engaging portions 41, 42. The engaging structure 33 of the corresponding support portion 32 engages detachably and slidably either one of the first and second engaging portions 41, 42. Each of the first and second engaging portions 41, 42 has an engaging surface 412, 422 that is connected to the connecting port ion 43 and that faces the engaging surface 412, 422 of the other one of the first and second engaging portions 41, 42, and an abutment surface 411, 421 that is opposite to the engaging surface 412, 422. A distance (L1, L2) between the abutment surface 411, 421 and the engaging surface 412, 422 of one of the first and second engaging portions 41, 42 is different from that of the other one of the first and second engaging portions 41, 42 (see FIGS. 5 and 8). In this embodiment, the distance (L1) between the abutment surface 411 and the engaging surface 412 is greater than that between the abutment surface 421 and the engaging surface 422. Each of the first and second engaging portions 41, 42 further has four positioning recesses 44, 45 that are formed in a periphery thereof.

The positioning units 5 correspond respectively to the support portions 32 of the base seat 3. Each of the positioning units 5 includes a ball body 51 that is movable along the retaining hole 34 of the corresponding support portion 32, a resilient member 52 that is disposed in the retaining hole 34 of the corresponding support portion 32 and that biases resiliently the ball body 51 toward the engaging space 334 of the corresponding support portion 32, and a stop member 53 that engages threadedly the retaining hole 34 of the corresponding support portion 32 and that is disposed at one side of the resilient member 52 distal from the ball body 51. Each of the positioning units 5 is operable to switch between a locking state where the ball body 51 is partially retained in the engaging space 334 of the corresponding support portion 32, and an unlocking state where the ball body 51 is totally retracted into the retaining hole 34 of the corresponding support portion 32.

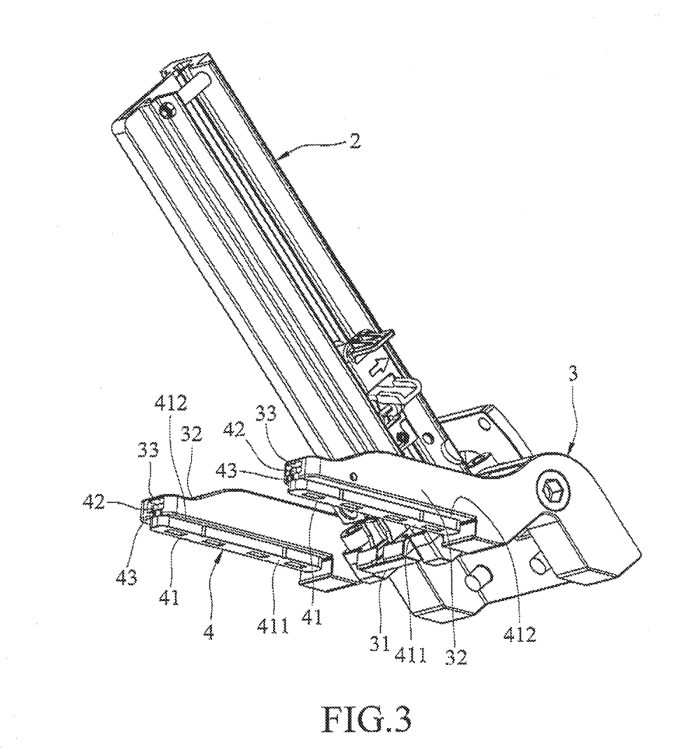

Referring to FIGS. 3 to 5, the engaging structure 33 of each of the support portions 32 is engageable with the second engaging portion 42 of the corresponding abutment member 4 such that: the second engaging portion 42 of each of the abutment members 4 is retained in the engaging space 334 of the corresponding support portion 32; the connecting portion 43 of each of the abutment members 4 is disposed between the distal wall segments 333 of the corresponding support portion 32; and the engaging surfaces 412, 422 of the first and second engaging portions 41, 42 of each of the abutment members 4 respectively abut against opposite sides of each of the distal wall segments 333 of the corresponding support portion 32. At this time, each of the positioning units 5 is in the locking state where the ball body 51 of each of the positioning units 5 engages one of the positioning recesses 45 of the corresponding abutment member 4 for prevent relative sliding movement between the corresponding support portion 32 and the corresponding abutment member 4.

Referring to FIG. 6, in operation of the nailer, the abutment surfaces 411 of the abutment members 4 (only one is shown) can be disposed to abut against the object 6, such that a distance between the object 6 and the base seat 3 is equal to the thickness of the first engaging portion 41 of each of the abutment members 4 (i.e., L1).

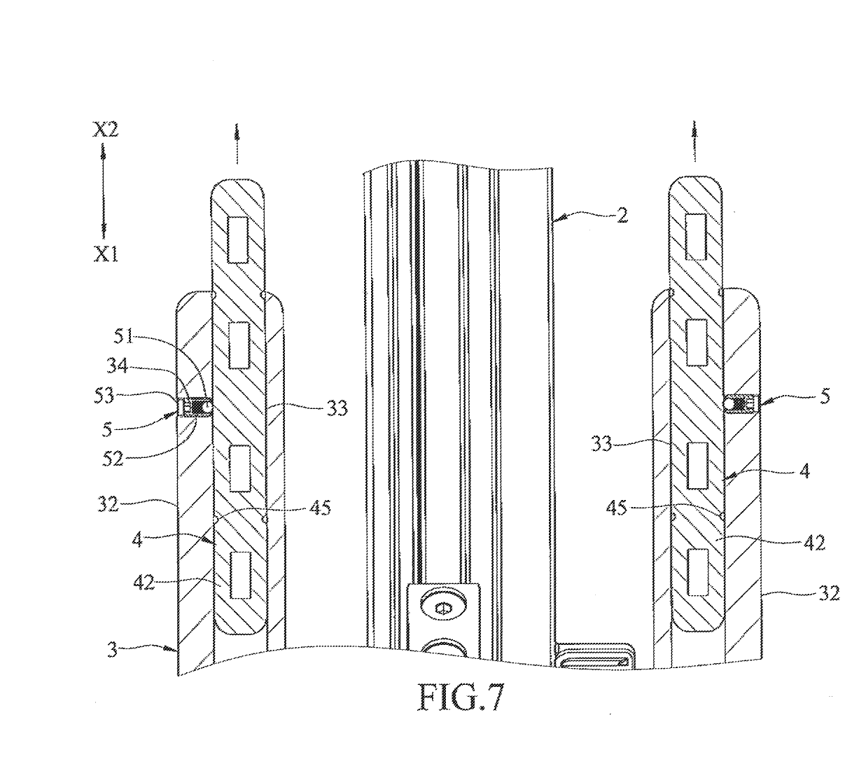

Referring to FIGS. 7 and 8, to adjust the distance between the object 6 and the base seat 3 in operation of the nailer, the first engaging portion 41 of each of the abutment members 4 is held manually and moved in a disengaging direction (X2) opposite to the engaging direction (X1) to force the corresponding positioning unit 5 to switch into the unlocking state where the ball body 51 of the corresponding positioning unit 5 is disengaged from the one of the positioning recesses 45 of the abutment member 4, so as to permit relative sliding movement between the corresponding support portion 32 and the abutment member 4, and to therefore disengage the second engaging portion 42 of the abutment member 4 and the corresponding support portion 32. Then, each of the abutment members 4 is inverted and moved relative to the base seat 3 in the engaging direction (X1), so as to drive the engaging portion 41 thereof to slide into the engaging space 334 the corresponding support portion 32 until the ball body 51 of the corresponding positioning unit 5 engages one of the positioning recesses 44 of the first engaging portion 41 for prevent relative sliding movement thereof relative to the corresponding support portion 32. Comparing FIGS. 5 and 8 and referring to FIG. 6, since the first and second engaging portions 41, 42 of each of the abutment members 4 are different in thickness (i.e., L1 and L2), the nailer can be operated to fire a nail 21 into different locations of the object 6.

To sum up, by virtue of the configuration of the engaging structures 33, the abutment members 4 and the positioning units 5, each of the abutment members 4 can be engaged with or disengaged from the corresponding engaging structure 33 manually and easily.

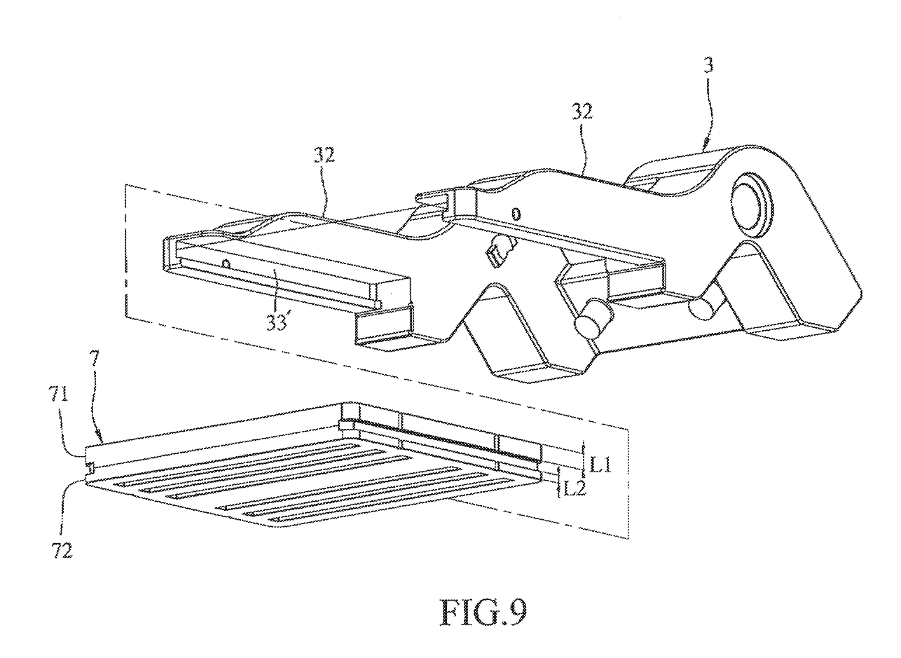

Referring to FIG. 9, a second embodiment of the nailer according to the present invention is similar to the first embodiment. The differences between the first and second embodiments reside in that the support portions of the base seat 3 of the second embodiment cooperatively form the engaging structure 33′, and that the second embodiment only includes one abutment member 7.

The engaging structure 33′ is configured to be similar to that of the first embodiment. The abutment member 7 is also configured to be similar to that of the first embodiment, and includes two engaging portions 71, 72 that have different thicknesses (L1, L2). The nailer can also be operated to fire a nail 21 into different locations of an object by engaging different engaging portions 71, 72 with the engaging structure 33′.

While the present invention has been described in connection with what are considered the most practical embodiment, it is understood that this invention is not limited to the disclosed embodiments but is intended to cover various arrangements included within the spirit and scope of the broadest interpretation so as to encompass all such modifications and equivalent arrangements.

What is claimed is:

1. A nailer adapted for firing a nail into an object, comprising:
a base seat having at least one engaging structure; and
at least one abutment member having at least two engaging port ions that are spaced apart from each other, and a connecting portion that is connected between said engaging portions, said engaging structure engaging detachably one of said engaging portions, each of said engaging portions having an engaging surface that is connected to said connecting portion and that abuts against said engaging structure, the other one of said engaging portions further having an abutment surface that is opposite to said engaging surface thereof, and that is adapted for abutting against the object.

2. The nailer as claimed in claim 1, wherein the one of said engaging port ions further has an abutment surface that is opposite to said engaging surface thereof, and that is adapted for abutting against the object when the one of said engaging portions is disengaged from said engaging structure and the other one of said engaging portions engages said engaging structure, a distance between said abutment surface and said engaging surface of the one of said engaging portions being different from that of the other one of said engaging portions.

3. The nailer as claimed in claim 1, wherein said engaging structure of said base seat and the one of said engaging portions of said abutment member are in slidable engagement.

4. The nailer as claimed in claim 3, wherein said engaging structure of said base seat has an elongate top wall segment, a pair of spaced-apart extending wall segments that are parallel to each other and that are adapted to extend from said top wall segment toward the object in a first direction, and a pair of distal wall segments that extend respectively from distal ends of said extending wall segments proximate to the object toward each other in opposite second and third directions, said top wall segment, said extending wall segments and said distal wall segments cooperatively defining an engaging space thereamong that extends in an engaging direction transverse to the first, second and third directions, the one of said engaging portions of said abutment member being retained in said engaging space, said connecting portion of said abutment member being disposed between said distal wall segments, said engaging surfaces of said engaging portions respectively abutting against opposite sides of each of said distal wall segments.

5. The nailer as claimed in claim. 4, further comprising a positioning unit that is operable to switch between a locking state and an unlocking state, so as to respectively prevent and permit relative sliding movement between said engaging structure and the one of said engaging portions.

6. The nailer as claimed in claim 5, wherein the one of said engaging portions is formed with a positioning recess, said base seat being formed with a retaining hole that communicates spatially with said engaging space, said positioning unit including a ball body and a resilient member, said ball body being movable along said retaining hole to engage said positioning recess to prevent the relative sliding movement between said engaging structure and the one of said engaging portion when said positioning unit is in the locking state, and to disengage said positioning recess to permit the relative sliding movement between said engaging structure and the one of said engaging portion when said positioning unit is in the unlocking state, said resilient member being disposed in said retaining hole for basing resiliently said ball body to engage said positioning recess.

7. The nailer as claimed in claim 6, wherein the one of said engaging portion is slidable relative to said engaging structure in the engaging direction.

8. The nailer as claimed in claim 1, wherein said base seat has two said engaging structures, said nailer comprising two said abutment members.
